(19) United States
(12) Patent Application Publication
(10) Pub. No.: US 2022/0383773 A1
(43) Pub. Date: Dec. 1, 2022

(54) System, Method, and Apparatus for Maneuver Training

(71) Applicant: Category, LLC, Largo, FL (US)

(72) Inventor: Maurycy Sokolowski, Largo, FL (US)

(73) Assignee: Category, LLC, Largo, FL (US)

(21) Appl. No.: 17/335,205

(22) Filed: Jun. 1, 2021

(51) Int. Cl. G09B 19/16; B64F 5/60; G09B 5/02

(52) U.S. Cl. CPC G09B 19/165; B64F 5/60; G09B 5/02; H04W 88/02

(57) ABSTRACT

A method and apparatus for maneuver training for an aircraft includes selecting a maneuver from a smartphone then determining a current location, a current velocity and a current direction of the aircraft by periodically reading a global positioning subsystem of the smartphone. Next, a tunnel for the maneuver is calculated from the current location, the current velocity, and the current direction and a first segment of the tunnel is displayed on a display of the smartphone; the tunnel represents boundaries of the maneuver. Thereafter, until the maneuver is completed, the current location of the aircraft is periodically read from the global positioning subsystem of the smartphone and subsequent segments of the tunnel are displayed on the display; the subsequent segments correspond to the current location of the aircraft.

### FIELD

This invention relates to training and more particularly to training of maneuvers in a vehicle such as an airplane.

### BACKGROUND

Training of drivers, operators, pilots, etc., often requires live operation of the vehicle (e.g., truck/car, boat, airplane) by the trainee to learn how to maneuver the actual vehicle. For example, even after extensive classroom and simulator training, the trainee must practice maneuvers such as backing into a loading dock, banked turns, docking a boat at a fueling station, all while operating an actual vehicle. Further, due to many dangers of such operations, a certified trainer is often involved to make sure the trainee is able to perform the requisite maneuvers for various stages of certification.

Unfortunately, the cost and certain logistical issues make it difficult to always have a trainer available for training and for certification. For example, practice time for maneuvers with a certified aviation trainer will be significant, not counting the cost of renting an aircraft.

What is needed is a system that will provide training in maneuvers in a consistent fashion while tracking performance of the trainee against the capabilities of the vehicle (e.g., aircraft).

### SUMMARY

A system for maneuver training includes a mobile device that is preprogrammed with one or more expected maneuvers. In the field of aviation, the maneuvers will include certain aircraft operations that must be mastered in order to get certified, for example, banked turns, steep spirals, turns around a point-in-space, etc. For a boat, the maneuvers will include, for example, docking, navigating between channel markers, proper stopping, etc. For a truck (18-wheeler), the maneuvers will include, for example, sharp turns, changing lanes, backing into a loading dock, etc. The mobile device has location determining subsystems such as GPS and, optionally, augmenting sensors such as gyroscopes, altimeters, and accelerometers. The maneuver is accessed and displayed on a display of the mobile device, then, as the trainee performs the maneuver, the location of the vehicle (and other parameters such as banking) are determined from the location determining subsystem and sensors and feedback is provided to the trainee as to the trainee's performance vis-à-vis the maneuver. In some embodiments, the trainee's performance is recorded and certified for review in a certification program. By using the system for maneuver training, the trainee is enabled to practice the maneuver without requiring the presence of a trainer, which not only saves the trainee money, but prevents the spread of communicable diseases such as Covid-19. The system for maneuver training provides consistent feedback to the trainee so that the trainee can better gauge their performance.

In one embodiment, a system for maneuver training in an aircraft is disclosed. The system for maneuver training in an aircraft, runs on a portable device that has display and a global positioning subsystem. The software running on the portable device receives a selection of a maneuver to be performed and prior to the maneuver being performed, the software running on the portable device receives a plurality of readings from the global positioning subsystem and the software running on the portable device calculates a current location, a current velocity, and a current direction from the plurality of readings. The software running on the portable device then calculates from the current location, the current velocity, and the current direction, a tunnel, the tunnel representing an expected path of the aircraft during the maneuver and the software running on the portable device displays a first portion of the tunnel on the display. Thereafter, until the maneuver is completed, the software running on the portable device periodically reads the global positioning subsystem and calculates the current location of the aircraft and the software running on the portable device displays subsequent segment of the tunnel on the display indicating movement of the aircraft through the tunnel.

In another embodiment, a method of maneuver training for a vehicle is disclosed. The method includes selecting a maneuver then determining, at a device, a current location, a current velocity and a current direction from which a tunnel is calculated. A first section of the tunnel is then displayed on a display of the device; the tunnel represents boundaries of the maneuver. Thereafter, until the maneuver is completed, periodically calculating the current location of the vehicle and updating the tunnel to correspond to the current location of the vehicle.

In another embodiment, a method of maneuver training for an aircraft is disclosed. The method includes selecting a maneuver from a smartphone then determining a current location, a current velocity and a current direction of the aircraft by periodically reading a global positioning subsystem of the smartphone. Next, a tunnel for the maneuver is calculated from the current location, the current velocity, and the current direction and a first segment of the tunnel is displayed on a display of the smartphone; the tunnel represents boundaries of the maneuver. Thereafter, until the maneuver is completed, the current location of the aircraft is periodically read from the global positioning subsystem of the smartphone and subsequent segments of the tunnel are displayed on the display; the subsequent segments correspond to the current location of the aircraft.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of system for maneuver training.

FIG. 2 illustrates a schematic view of a typical cell phone for execution of the system for maneuver training.

FIG. 3 illustrates a schematic view of a typical computer system such as a server or personal computer.

FIG. 4 illustrates an exemplary set of parameters for a certain vehicle (airplane) of the system for maneuver training.

FIG. 5 illustrates an exemplary user interface of the system for maneuver training showing selections for several maneuvers.

FIG. 6 illustrates an exemplary user interface of the system for maneuver training showing a check list for a specific maneuver.

FIG. 7 illustrates an exemplary user interface of the system for maneuver training showing a selection for several performing such maneuver.

FIG. 8 illustrates a sequence of views showing an exemplary user interface as the operator performs one such maneuver.

FIGS. 9, 10, 11, and 12 illustrate schematic views of measurements and predicted locations before and during a sample maneuver.

FIG. 13 illustrates an exemplary program flow of the system for maneuver training.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In general, the maneuver training system provides capabilities to a trainee for learning, practicing, and perfecting certain maneuvers of the vehicle (e.g., aircraft, truck, boat, car) that the trainee is learning to operate. Throughout this description, an aircraft and flying maneuvers are used as examples, though any vehicle and any type of maneuver is anticipated, in the air, in space, in water, or on the ground.

Throughout this description, a smartphone is used as an example of a portable device that is used as a tool during performance of the maneuver, though any portable device that has location determining capabilities is anticipated, for example, a tablet computer with a global positioning subsystem.

Throughout this description, a global positioning satellite receiver, as typically found in most smartphones, is used as a location determining device, though any known or future location determining device is fully anticipated (for example, Loran or cell tower triangulation).

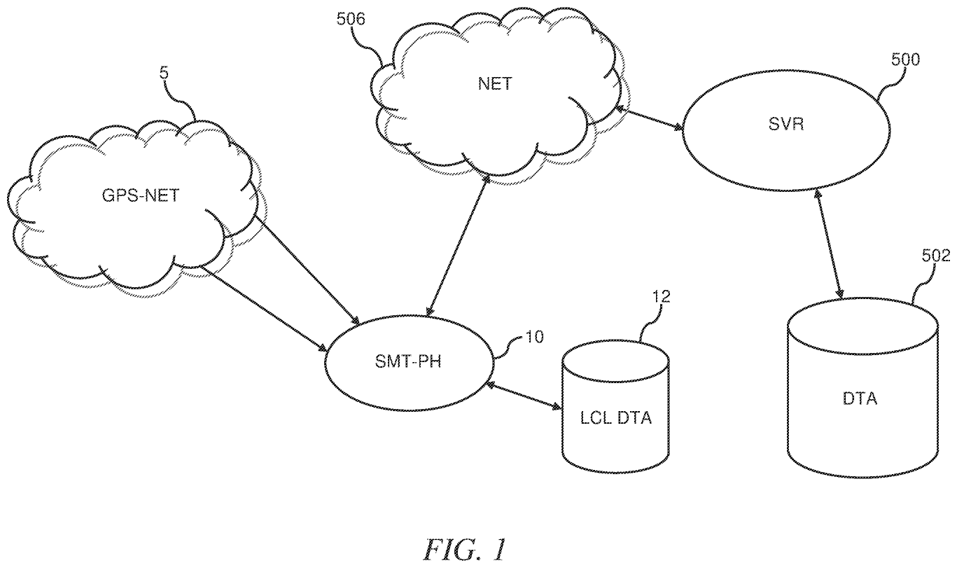

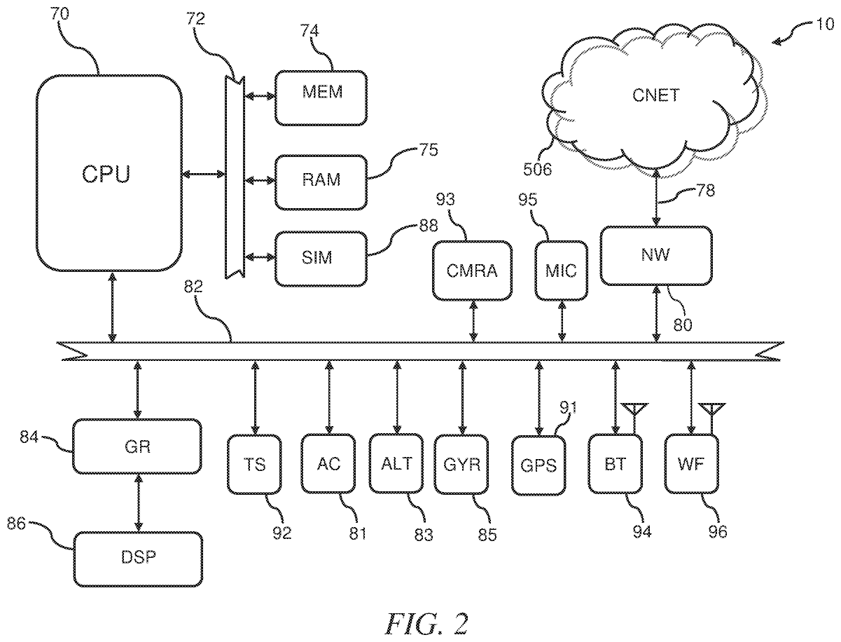

Referring to FIG. 1 illustrates a data connection diagram of the maneuver training system. In this example, one or more smartphones 10 communicate through a data network 506 (e.g., cellular network and/or local networks and/or the Internet) to a server computer 500. Any known communications path is anticipated. For example, the Wi-Fi transceiver 96 (see FIG. 2) of the smartphone 10 is used to communicate directly with the Internet, and, consequently, with the server computer 500.

The server computer 500 transacts with the smartphones 10 through the data network(s) 506 and presents menus on the smartphones 10 (e.g., through a browser or dedicated application). The server computer also provides data to the smartphones 10 and receives back feedback regarding maneuvers performed and performance of the trainee, etc. In some embodiments, login credentials (e.g., passwords, pins, secret codes) are stored local to the smartphone 10; while in other embodiments, login credentials are stored in a data storage 502 (preferably in a secured area) requiring a connection to login.

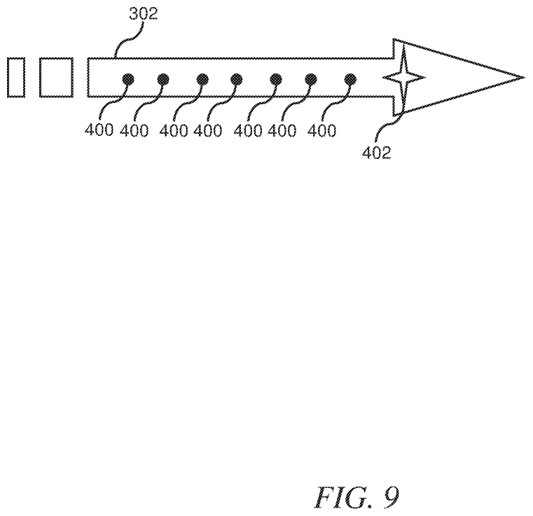

In some embodiments, the data storage 502 includes data regarding each possible vehicle (e.g., data regarding each aircraft 402 (see FIGS. 9-12) such as range of speed, turning radius, maximum lift) and possible maneuvers (e.g., bank turn maneuver, loop maneuver). It is anticipated that some or all of such data is downloaded into a local data storage 12 of the smartphone 10 before or during execution of the maneuver(s).

In some embodiments, the server computer 500 transacts with a maneuver training application running on the smartphone 10.

In the maneuver training system, the location of the smartphone 10 (and hence the aircraft 402 as in FIGS. 9-12) is determined by reading a location determining subsystem of the smartphone 10 such as the global positioning subsystem 91 (see FIG. 2).

Referring to FIG. 2, a schematic view of a typical smartphone 10 is shown. The example smartphone 10 represents a typical phone system used for training using the maneuver training system. This exemplary smartphone 10 is shown in its simplest form. Different architectures are known that accomplish similar results in a similar fashion and the present invention is not limited in any way to any particular smartphone 10 system architecture or implementation. In this exemplary smartphone 10, a processor 70 executes or runs programs in a random-access memory 75. The programs are generally stored within a persistent memory 74 and loaded into the random-access memory 75 when needed. Also accessible by the processor 70 is a SIM card 88 (subscriber information module) having a subscriber identification and often persistent storage. The processor 70 is any processor, typically a processor designed for smartphones 10. The persistent memory 74, random-access memory 75, and SIM card are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary smartphones 10, the persistent memory 74 is removable, in the form of a memory card of appropriate format such as SD (secure digital) cards, micro-SD cards, compact flash, etc.

Also connected to the processor 70 is a system bus 82 for connecting to peripheral subsystems such as a network interface 80, a graphics adapter 84 and a touch screen interface 92. The graphics adapter 84 receives commands from the processor 70 and controls what is depicted on a display 86. The touch screen interface 92 provides navigation and selection features.

In general, some portion of the persistent memory 74 and/or the SIM card 88 is used to store programs, executable code, phone numbers, contacts, and data, etc. In some embodiments, other data is stored in the persistent memory 74 such as audio files, video files, text messages, vehicle parameters (e.g., aircraft parameters), maneuvers, performance data, etc.

The peripherals are examples and other devices are known in the industry such as Global Positioning Subsystem 91, speakers, microphones, USB interfaces, Bluetooth transceiver 94, Wi-Fi transceiver 96, camera 93, microphone 95, acceleration sensors 81, altitude sensors 83, gyroscopic sensors 85, etc., the details of which are not shown for brevity and clarity reasons.

The network interface 80 connects the smartphone 10 to the data network 506 through any cellular band and cellular protocol such as GSM, TDMA, LTE, 5G, etc., through a wireless medium 78. There is no limitation on the type of cellular connection used. The network interface 80 provides voice call, data, and messaging services to the smartphone 10 through the cellular network.

For local communications, many smartphones 10 include a Bluetooth transceiver 94, a Wi-Fi transceiver 96, or both. Such features of smartphones 10 provide data communications between the smartphones 10 and data access points and/or other computers such as a personal computer (not shown).

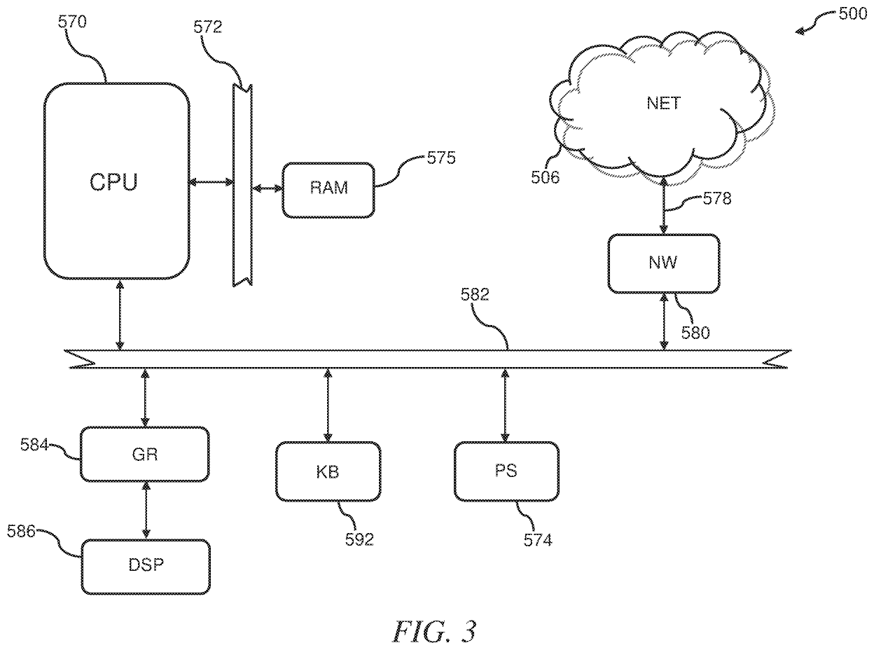

Referring to FIG. 3, a schematic view of a typical computer system (e.g., server computer 500) is shown. The example computer system represents a typical computer system used for creating/storing vehicle information, maneuver plans, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display image on the display 586. The keyboard interface 592 provides navigation, data entry, and selection features. The network interface 580 connects to the data network 506 through a network path 578 such as Ethernet, 4G, LTE, 5G, etc.

In general, some portion of the persistent memory 574 is used to store programs, executable code, data, contacts, and other data, etc.

The peripherals are examples and other devices are known in the industry such as speakers, microphones, USB interfaces, Bluetooth transceivers, Wi-Fi transceivers, image sensors, temperature sensors, etc., the details of which are not shown for brevity and clarity reasons.

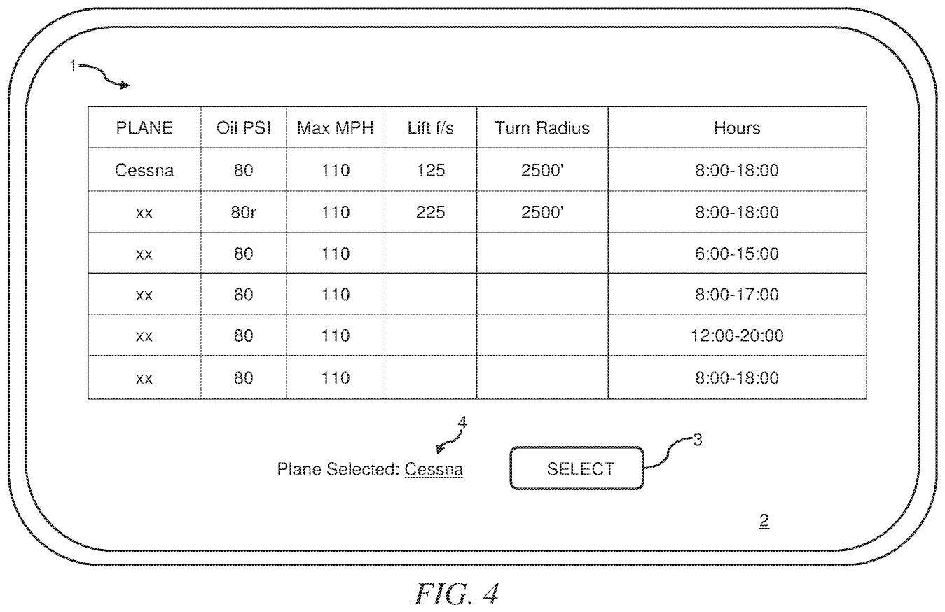

Referring to FIG. 4, an exemplary set of parameters 1 for a certain vehicle (e.g., aircraft 402) of the system for maneuver training. Although many various vehicles are anticipated, an aircraft 402 is used as an example throughout this description. In general, an operator (e.g., trainee, pilot, driver) must practice and eventually perform a certain set of maneuvers in order to meet a required criterion (e.g., get a pilot's license, a training certificate . . . ). In the past, the operator performed such maneuvers in an aircraft 402 with an instructor, getting feedback from the instructor, accumulating flight hours (experience), and being evaluated by the instructor. With the system for maneuver training, the operator performs the maneuvers without the need for an instructor (note that the system for maneuver training also works well in the presence of an instructor). In such, the operator performs the maneuver(s) in an aircraft 402 under guidance and monitoring of the system for maneuver training which is running on a local device such as a smartphone 10.

FIG. 4 has a set or parameters 1 the includes various capabilities of possible aircraft 402 and the operator selects an aircraft 402 from the list (at least a similar aircraft 402 from the list that is similar to that which they will use for training). Note that it is equally anticipated to use a simple selector for a range of aircraft 402 such as small/medium/large or single propeller, dual propeller, jet, etc. Note that some maneuvers are not performed on all possible aircraft 402.

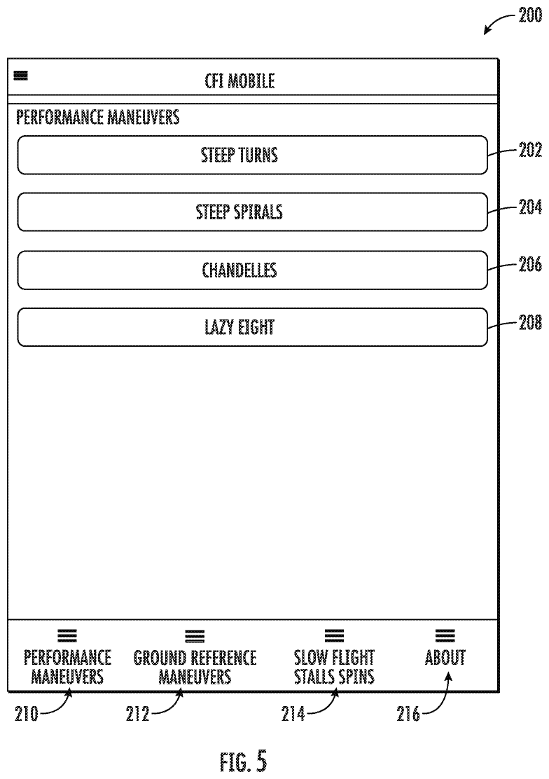

Referring FIG. 5, an exemplary user interface of the system for maneuver training showing selections for several maneuvers 200. In this, the operator selects the maneuver 202/204/206/208 to be performed such as a steep turn maneuver 202, a steep spiral maneuver 204, a chandelle maneuver 206, and a lazy-eight maneuver 208. Note that there is no limit on the number or type of maneuver 202/204/206/208 and, in some embodiments, the types of maneuvers 202/204/206/208 are restricted by the type of aircraft 402 (e.g., certain maneuvers 202/204/206/208 are not possible on certain aircraft 402).

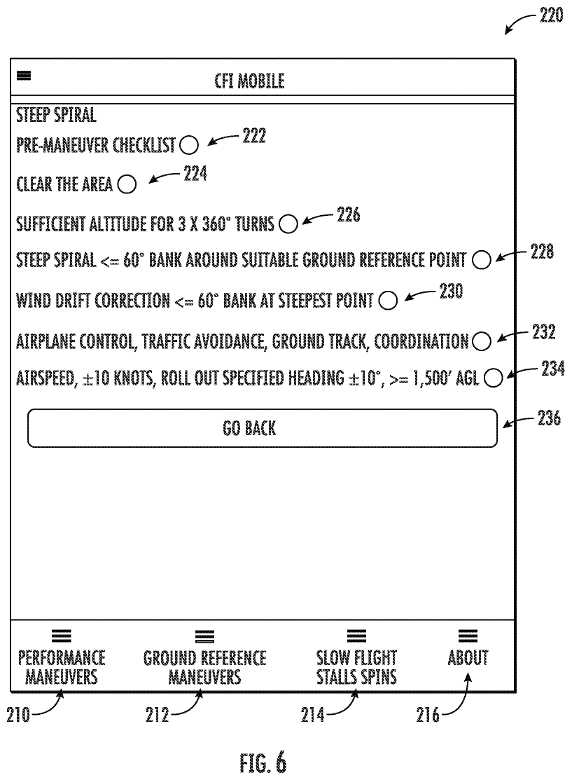

Referring FIG. 6, an exemplary user interface of the system for maneuver training showing a check list for a specific maneuver 220. Once the maneuver is selected (e.g., the Steep Spiral maneuver 204 of FIG. 5), a check list for that specific maneuver 220 is displayed similar to that in FIG. 6. In this, the operator is in the air and must make sure that certain external and internal parameters 222/224/226/228/230/232/234/236 are up to requirements for performing the specific maneuver. For example, before performing the Steep Spiral Maneuver 204, the operator must make sure that the area is clear of other aircraft 224, that the aircraft 402 is at sufficient altitude 225 for performing the maneuver, etc. Although not shown, in some embodiments, other aircraft 402 parameters such as oil pressure and fuel reserve are also included in the checklist as such maneuvers put a strain on the engine(s) and require a certain amount of fuel. In some embodiments, the maneuver training system provides automated checking of certain safety parameters (or double-checking what the operator sees) by, for example, electronically determining altitude and making sure there is sufficient altitude over ground from the selected maneuver or using Auto Dependent Surveillance Broadcast (ADS-B) to automatically determine if other aircraft are too close to safely perform the selected maneuver.

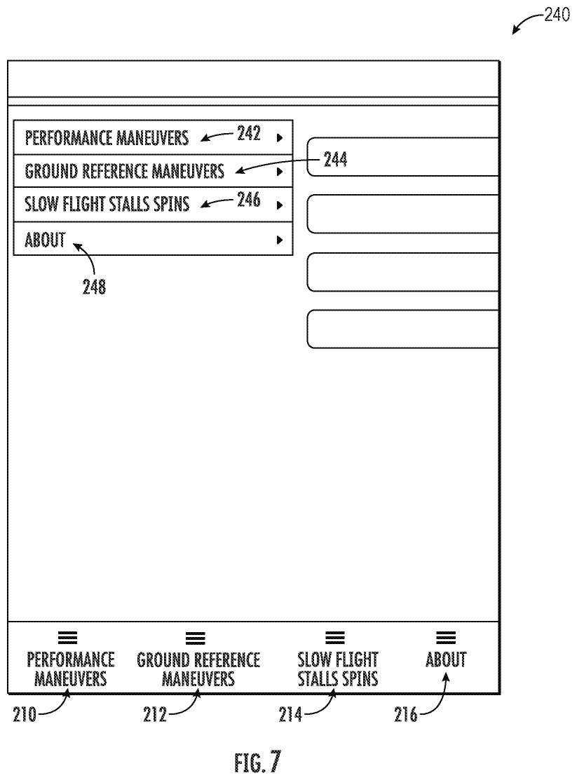

Referring FIG. 7, an exemplary user interface 240 of the system for maneuver training showing a selection for several specific maneuvers 242. In this exemplary user interface 240, the user swipes right to initiate further user interfaces to perform maneuvers 242, to perform ground-reference maneuvers 244, to perform slow flight stall spins 246, or to reach a user interface 248 that informs about the program.

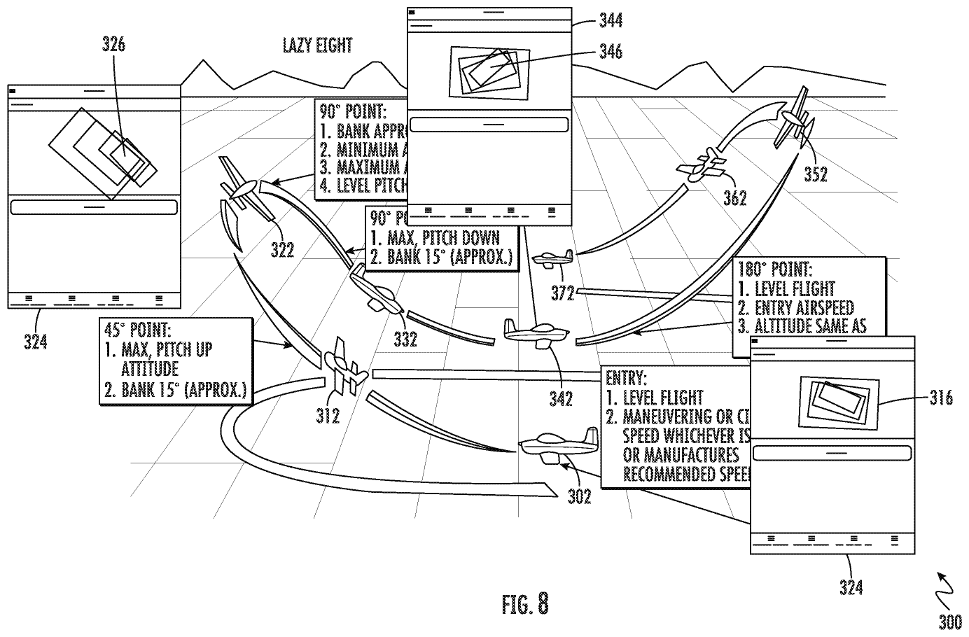

Referring FIG. 8, a sequence of views of the system for maneuver training showing an exemplary user interface as the operator performs one such maneuver. In this example, the operator has selected the “Lazy Eight” maneuver 208 and has completed the check list associated with the “Lazy Eight” maneuver 208 and the operator is ready to perform this maneuver.

Once the operator completes the checklist of FIG. 6, the operator is presented with a first user interface 304, showing an imaginary tunnel 306 through which the operator must fly the aircraft 402. The aircraft 402 is shown in FIG. 8 in various positions 302/312/322/332/342/352/362 as it traverses the Lazy Eight maneuver 208. In the first user interface 304, as the aircraft 402 is in a first position 302, the imaginary tunnel 306 shows a progression of rectangles (or any shape) that bank (right wing down) and show the aircraft 402 needs to turn to the right. As the aircraft 402 progresses through the maneuver, the imaginary tunnel 306 changes to continuously show the operator what is coming; the successive pitch (banking) and turning (or keeping on course) that are required to complete the selected maneuver. In the example of FIG. 8, when the aircraft 402 reaches the third position 322, the imaginary tunnel 326 shows a progression of rectangles (or any shape) that bank more (right wing further down) and show the aircraft 402 needs to turn to the right at a tighter turning radius. When the aircraft 402 reaches the fourth position 342, the imaginary tunnel 346 shows a progression of rectangles (or any shape) that bank left (left wing down) and show the aircraft 402 needs to turn to the left.

Referring to FIGS. 9, 10, 11, and 12, schematic views of measurements and predicted locations before and during a sample maneuver are shown. For brevity and clarity, a single loop maneuver is shown.

In FIG. 9, the aircraft 402 if flying in the direction of the direction indicated by the first position 302. Several GPS position measurements 400 were taken previously to calculate a current location (e.g., latitude, longitude, and altitude), a current direction, and a current velocity of the aircraft 402, using the global positioning subsystem 91 of the smartphone 10. The global positioning subsystem 91 uses signals from three GPS satellites to determine latitude and longitude, but when signals from four GPS satellites are available, the global positioning subsystem 91 also determines altitude. In some embodiments in which the smartphone 10 includes acceleration sensors 81, altitude sensors 83, and/or gyroscopic sensors 85, such sensors are used to improve the accuracy and detail of the GPS position measurements 400. For example, in an embodiment in which the smartphone 10 includes a gyroscopic sensor 85, pitch of the aircraft 402 is determined from the gyroscopic sensor 85 and the pitch of the aircraft 402 is displayed and/or tracked through the maneuver for later reporting.

Several GPS position measurements 400 are made, for example, several per second, to determine the latitude, longitude, altitude, and direction of the aircraft 402. As the aircraft 402 typically has an unobstructed view of at least four GPS satellites, at each GPS position measurement 400, the latitude, longitude, and altitude of the aircraft 402 is received from the global positioning subsystem 91. The system for maneuver training then extracts from several GPS position measurements 400 a direction (e.g., vector) and velocity of the aircraft 402.

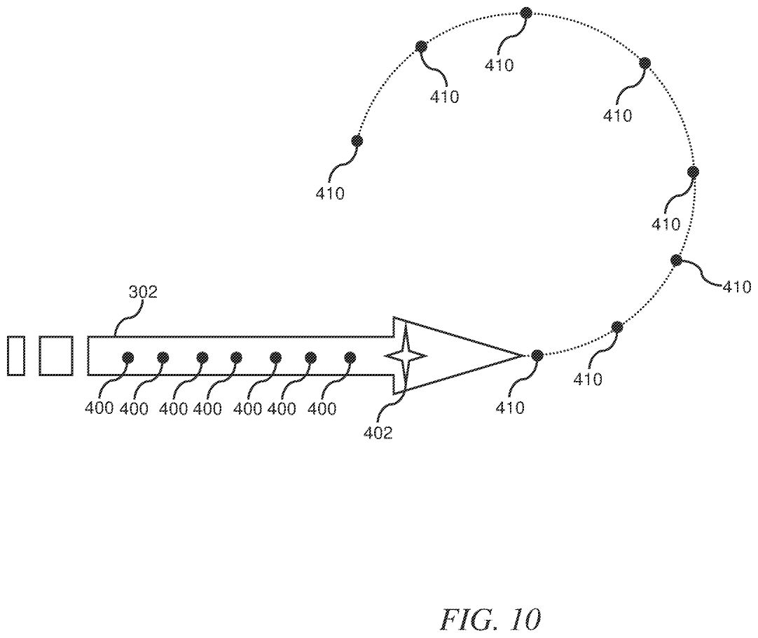

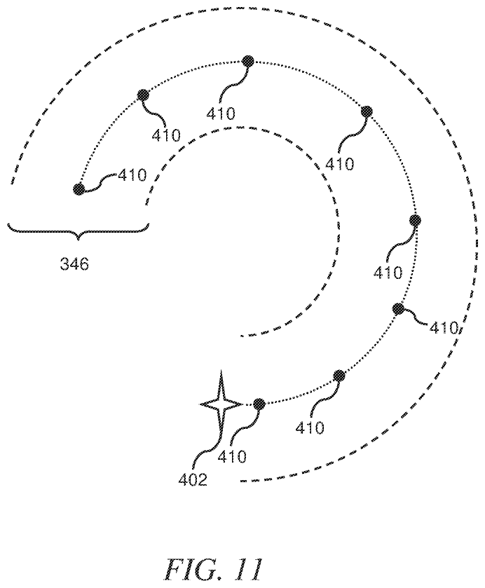

Now, knowing the direction (e.g., vector) and velocity of the aircraft 402, the system for maneuver training generates a series of waypoints 410 that indicate where the aircraft 402 should be at successive times during the maneuver (see FIG. 10) then the system for maneuver training calculates a tunnel for the maneuver and displays a first segment of the tunnel 346 (see FIG. 11) that indicates the range of locations in which the aircraft 402 should progress during the next steps of the maneuver as in FIG. 8.

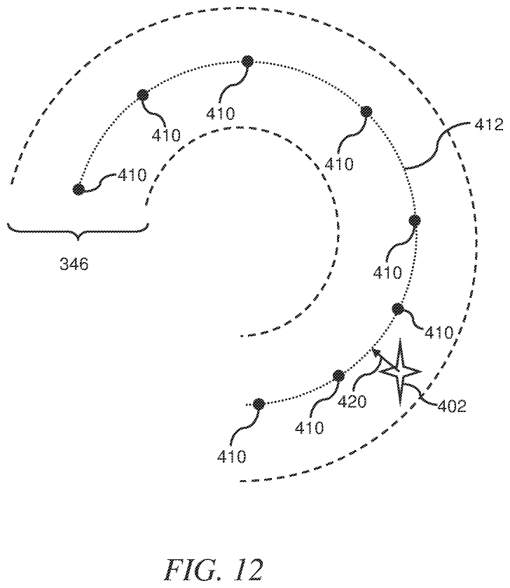

In FIG. 12, the maneuver has begun and periodically, the global positioning subsystem 91 is read to determine the current location of the aircraft 402. The aircraft 402 has now progressed into the tunnel 346 and a subsequent segment of the tunnel 346 is displayed. In this example, the current location of the aircraft is away from the centerline 412 of the tunnel 346 by an error distance 420. As the aircraft 402 is still within the tunnel 346, this error distance 420 is noted and reported to the pilot. In some embodiments, if the error distance 420 indicates that the aircraft 402 is outside of the tunnel 346, a warning message is displayed to warn the pilot that there may be danger due to an improper maneuver. Note that as the real aircraft moves, subsequent segments of the tunnel 346 are displayed to show progression through the tunnel 346 and guide the pilot through the maneuver until the maneuver is complete.

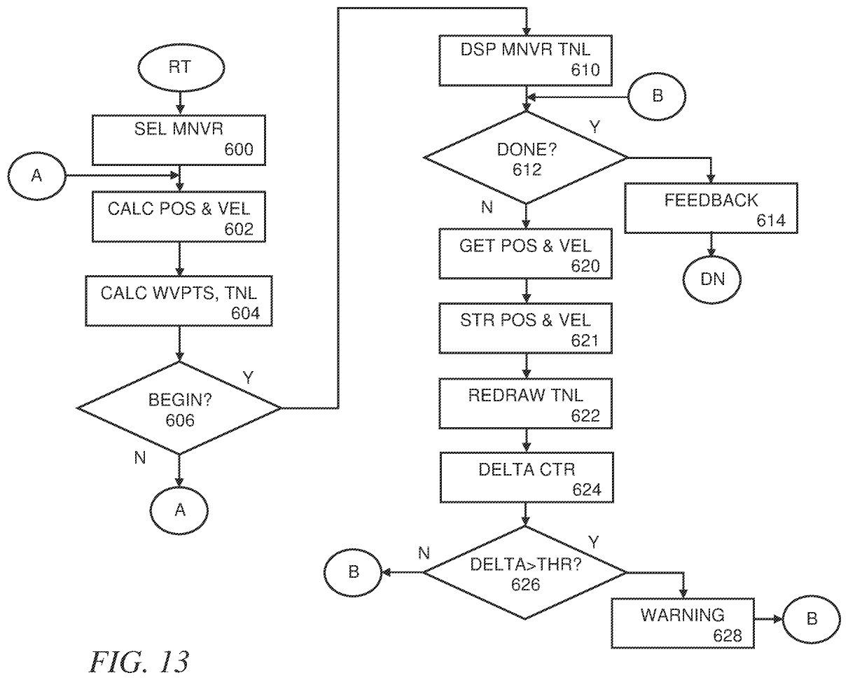

Referring to FIG. 13 illustrates an exemplary program flow of software that runs on the portable device of the system for maneuver training. First, a maneuver is selected 600 (e.g., lazy-eight). Then, as described above, the current location (latitude, longitude, and altitude) and velocity with direction is determined 602 as described in FIGS. 9-12. Next, several waypoints and then the tunnel are calculated 604. These repeat until the pilot indicates that they are ready to begin 606 the maneuver or it is detected that the aircraft 402 has deviated from the current straight path. At this time, the calculated tunnel 346 is displayed 610.

A loop (B) begins with a check as to whether the maneuver is completed 612 and, if so, feedback 614 is provided to the pilot indicating performance with regard to the maneuver. In some embodiments, the maneuver being completed 612 is determined when the final turns of the maneuver are completed.

If not completed 612, the global positioning subsystem 91 is read 620 to get the current location and the velocity and direction are calculated using the previous readings for the global positioning subsystem 91 and a subsequent segment of the tunnel is drawn 622 from the new position on the display 86 of the smartphone 10. In some embodiments, the current location is stored 621 in a memory of the smartphone 10 for later generation of a report showing progress through the maneuver.

Now, in some embodiments, an error distance 420 is calculated 624 between the current location of the aircraft 402 and the centerline 412 and if that error distance 420 is greater 626 than a threshold (e.g., a radius or width of the tunnel 346), then a warning 628 is issued (e.g., the aircraft 402 is outside of the tunnel 346).

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for maneuver training in an aircraft, the system comprising:
a portable device having a display and a global positioning subsystem;
software running on the portable device receives a selection of a maneuver to be performed;
prior to the maneuver being performed, the software running on the portable device receives a plurality of readings from the global positioning subsystem and the software running on the portable device calculates a current location, a current velocity, and a current direction from the plurality of readings;
the software running on the portable device calculates from the current location, the current velocity, and the current direction, a tunnel, the tunnel representing an expected path of the aircraft during the maneuver;
the software running on the portable device displays a first portion of the tunnel on the display; and
until the maneuver is completed, the software running on the portable device periodically reads the global positioning subsystem and calculates the current location of the aircraft and the software running on the portable device displays subsequent segment of the tunnel on the display indicating movement of the aircraft through the tunnel.

2. The system of claim 1, further comprising:
when the software running on the portable device periodically reads the global positioning subsystem and determines the current location of the aircraft, if the current location of the aircraft is outside of the tunnel, the software running on the portable device displays a warning message.

3. The system of claim 1, further comprising:
when the software running on the portable device periodically reads the global positioning subsystem and determines the current location of the aircraft, the software running on the portable device stores the current location of the aircraft in a storage of the portable device.

4. The system of claim 3, further comprising:
after the maneuver is completed, the current locations of the aircraft that were saved in the storage of the portable device are retrieved and integrated into a report.

5. The system of claim 1, wherein the portable device is a smartphone.

6. The system of claim 1, wherein the maneuver is selected from the group consisting of a steep turn maneuver, a steep spiral maneuver, a chandelle maneuver, and a lazy-eight maneuver.

7. A method for maneuver training for a vehicle, the method comprising:
selecting a maneuver;
determining, at a device, a current location, a current velocity and a current direction;
calculating a tunnel from the current location, the current velocity, and the current direction;
displaying on a display of the device a first section of the tunnel, the tunnel representing boundaries of the maneuver; and
until the maneuver is completed, periodically calculating the current location of the vehicle and updating the tunnel to correspond to the current location of the vehicle.

8. The method of claim 7, wherein the vehicle is an aircraft.

9. The method of claim 8, wherein the device is a smartphone.

10. The method of claim 9, wherein the step of determining, at the device, the current location, the current velocity and the current direction comprises periodically reading data points from a global positioning subsystem of the smartphone and calculating the current location, the current velocity and the current direction from the data points.

11. The method of claim 9, the step of periodically calculating the current location of the vehicle and updating the tunnel to correspond to the current location of the vehicle further comprises storing the current location of the vehicle in a storage of the smartphone.

12. The method of claim 11, further comprising, after the maneuver is completed, retrieving the current locations of the vehicle that were saved in the storage of the smartphone and generating a report.

13. A method for maneuver training for an aircraft, the method comprising:
selecting a maneuver from a smartphone;
determining a current location, a current velocity and a current direction of the aircraft by periodically reading a global positioning subsystem of the smartphone;
calculating a tunnel for the maneuver from the current location, the current velocity, and the current direction;
displaying on a display of the smartphone, a first segment of the tunnel, the tunnel representing boundaries of the maneuver; and
until the maneuver is completed, periodically reading the current location of the aircraft from the global positioning subsystem and displaying subsequent segments of the tunnel on the display, the subsequent segments corresponding to the current location of the aircraft.

14. The method of claim 13, wherein the step of determining the current location and the current direction of the aircraft comprises periodically reading data points from the global positioning subsystem of the smartphone, the data points including the current location, and calculating the current velocity and the current direction from the data points.

15. The method of claim 14, wherein the step of periodically reading the current location of the aircraft from the global positioning subsystem further comprises storing the current location of the aircraft in a storage of the smartphone.

16. The method of claim 15, wherein the smartphone further comprises a gyroscope and the step of periodically reading the current location of the aircraft from the global positioning subsystem further comprises reading the gyroscope and storing a current banking of the aircraft in the storage of the smartphone.

17. The method of claim 15, further comprising, after the maneuver is completed, retrieving the current locations of the aircraft that were saved in the storage of the smartphone and generating a report.
